(19) United States
(12) Patent Application Publication
(10) Pub. No.: US 2008/0320093 A1
(43) Pub. Date: Dec. 25, 2008

(54) Controlling the sending of electronic mail

(75) Inventor: Philip Lester Thorne, Alameda, CA (US)

Correspondence Address: Philip Thorne, Suite 100, 2150 Mariner Square Drive, Alameda, CA, 94501, US

(73) Assignee: Goolara, LLC, Alameda, CA (US)

(21) Appl. No.: 12/214,731

(22) Filed: Jun. 20, 2008

Related U.S. Application Data
(60) Provisional application No. 60/936,545, filed on Jun. 20, 2007.

(51) Int. Cl. G06F 15/16

(52) U.S. Cl. 709/206

(57) ABSTRACT

The present invention is directed to systems and methods for sending individual email messages in a batch, and monitoring the information returned from every receiving mail server to make sure that the failure rate for each server does not rise too high. Two running counts are maintained for every receiving mail server—one count for successful delivery messages, another count for failed delivery messages. A calculation is maintained based on the number of success messages divided by the number of failure messages for each receiving mail server. The calculated result is treated like a score, and is compared to a pre-set value. When the pre-set value is met or exceeded for an individual receiving mail server, the continued sending of email messages to the mail server is stopped. A notification is provided to the sending mail server administrator indicating mail to the individual receiving mail server was stopped. The administrator can review a log of all returned mail and determine whether to re-start the mail batch or remove the batch from the queue for further analysis.

### CROSS-REFERENCE TO RELATED APPLICATIONS

This application claims benefit under 35 U.S.C. §120 of provisional application Ser. No. 60/936,545, titled “Method and Apparatus for Controlling the Sending of Electronic Mail,” filed Jun. 20, 2007, and incorporated by reference herein in its entirety and for all purposes.

### BACKGROUND OF THE INVENTION

1. Field of the Invention

The present invention relates generally to online software applications. More specifically, it relates to systems and methods for monitoring, tracking and controlling the sending of email messages to increase the deliverability of the messages.

2. Description of the Related Art

The term “email” is an abbreviation for electronic mail, which can also be called “e-mail” or simply “mail”. Email is a method of composing, sending, receiving and storing messages on electronic communication systems, which includes a variety of methods for receiving and sending email. Email sent and received according to the RFP 821 protocol for SMTP mail is considered the defacto standard for email transmission across the Internet.

The term “mail server” refers to a computer application designed to send and receive email messages over the Internet. To successfully send an email message, there must be two conceptual mail servers—a sending mail server and a receiving mail server—although a single mail server can operate in both capacities.

Every mail server uses a unique IP address combined with a port number to send and receive email. An IP address, also called Internet Protocol address, is a unique address that electronic devices can use to identify and communicate with each other on a computer network, using the Internet Protocol. Every mail server also has an administrator, which is responsible for the operation of the mail server and can configure the operation of the mail server.

Email is increasingly used to deliver a large volume of unwanted and unsolicited messages, also called “spam”. Software can be installed on receiving mail servers that detects incoming email messages, and configured to deny delivery to individual messages for a variety of reasons. In most cases, information regarding the denied message is sent back to the sending mail servers indicating why the message was not delivered.

Various types of computer applications can operate on mail servers and attempt to identify spam automatically, and delete messages that are identified as spam. The applications use a variety of methods and processes that vary in effectiveness. Mail servers have the option of preventing more email from being received from specific mail servers, and can block individual sending mail servers temporarily or permanently.

Historically, sending mail servers have not reacted dynamically to messages from receiving mail servers. Sending mail servers typically try every recipient and mailing combination until it gets an error, or the mail is delivered, but the sending mail server does not stop delivery attempts even when the receiving mail servers return increasingly more errors.

### SUMMARY OF THE INVENTION

Methods and system for controlling the transmission of emails in a batch from a sending mail server to a receiving mail server are described. In one embodiment, a batch of messages or emails is sent to a receiving server. The receiving server sends back multiple return codes in response to receiving each message in the batch. A return code generally indicates whether the message was accepted by the receiving server or rejected. An accepted message results in a “success” return code to the sending server and a rejected message results in an “error” return code. A running count of the total number of messages being sent is maintained by the sending server and is used in calculations, described below.

The error return codes sent back to the sending server are separated into two groups. One is for error return codes which indicate that the error caused by the email at the receiving mail server may cause harm to the reputation of the sending mail server with respect to the receiving mail server, where such errors may be referred to as reputation-impacting errors. Another is for error return codes which indicate that the error caused by the email at the receiving mail server will likely not cause harm to the reputation of the sending mail server. A running count is kept of the number of the number of reputation-impacting errors. The two counts are used in a computation to calculate a ratio or percentage of reputation-impacting errors to total number of messages sent. This computation is performed after each message in the batch is sent to the receiving mail server.

The ratio is computed continuously while messages are sent and returns codes are being received. The ratio is compared to a previously set ratio (for example, by a network administrator) to determine whether the sending mail server should continue sending mail messages to the receiving mail server. The goal is to ensure that the reputation of the sending mail server from the perspective of the receiving mail server is not negatively impacted. If the transmission is stopped, a network administrator may examine the transmission history of the emails being sent and determine whether to resume transmission of messages or discontinue sending messages to the server.

### BRIEF DESCRIPTION OF THE DRAWINGS

References are made to the accompanying drawings, which form a part of the description and in which are shown, by way of illustration, particular embodiments:

FIG. 1 is a flow diagram of a process for controlling the transmission of mail from a sending mail server to a receiving mail server in accordance with one embodiment of the present invention; and

FIG. 2 is a block diagram of a generic server computer capable of implementing various embodiments of the present invention.

### DETAILED DESCRIPTION OF SPECIFIC EMBODIMENTS

Generally, the present invention provides improved methods of transmitting email messages. While the invention is described in terms of a few specific embodiments, it is by no means so limited. Numerous specific details of these embodiments are set forth in order to provide a thorough understanding of the present invention. It will be apparent, however, that the present invention may be practiced without limitation to some of the specific details presented herein.

Reference will now be made in detail to specific embodiments of the invention including the best modes contemplated by the inventors for implementing the invention. Examples of these specific embodiments are illustrated in the accompanying drawings. While the invention is described in conjunction with these specific embodiments, it will be understood that these embodiments are not intended to limit the invention to the described embodiments. On the contrary, it is intended to cover alternatives, modifications, and equivalents as may be included within the spirit and scope of the invention as defined by the appended claims.

Deliverability is a key metric for people and companies that send a large volume of email. Email delivery not allowed because the receiving email server has blocked the sending mail server can cause significant problems and expense for email senders. In one embodiment, a method of ensuring continued email deliverability is to remain below the receiving mail server's threshold of rejection, which triggers the mail server to stop receiving messages from a specific sending email server.

The reputation of a sending mail server is a key component that determines whether email from the sending mail server will be allowed to be delivered. Receiving mail servers keep track of all mail and where it comes from, and respond to every mail message it receives. Mail sending servers that establish a poor reputation for sending unsolicited and unwanted mail may be blocked, which prevents future mail from being delivered. As a consequence, it is critical for companies and people interested in delivering mail that they maintain a good reputation for their sending mails servers. If proper care is not taken to establish, maintain and protect their good reputation, it may become difficult to send mail to receiving mail servers.

The reputations of sending mail servers are determined by an objective score. Receiving mail servers determine the score of sending mail servers dynamically—every individual email message from a single email server is analyzed, and each subsequent piece of mail delivered from the same server impacts the score for the server. It is possible for a sending mail server to establish a good reputation for a period of time and then start sending mail that is flagged by the receiving server as inappropriate, which lowers the sending server's reputation score. Once a reputation score goes down, it may be difficult to bring it back up again, since less mail will be allowed in from the sending server. Therefore it is imperative that sending mail servers react dynamically and quickly to messages provided by receiving mail servers.

The present invention operates on sending mail servers, and is designed to keep a running count of all messages sent to individual mail servers, identify the number of messages that are denied delivery from each receiving mail server, where a notification is returned to the sending mail server, and calculating the percentage of undelivered email. The sending mail server operator or administrator can set a threshold value percentage before mailing each batch of email messages, which when exceeded by the calculated percentage stops the mailing of any more messages. This mechanism relieves the receiving mail servers from making the determination to deny any more delivery and possibly blocking the sending mail server.

One embodiment of the present invention is a method including the following high-level steps:

tracking the sending of all messages in a batch to every mail server that receives messages from the batch;

detecting response messages generated by each receiving mail server regarding mail sent in the batch;

maintaining a running count of two numbers—1) success messages, which are given a positive value, and 2) error messages, which are given a negative value depending on the severity of the failure;

calculating a numeric value from the running total based on the two counts for every receiving email server (the value represents the “reputation” of the sending mail server as perceived by the individual receiving mail server); and

slowing down or stopping the sending of email to any receiving mail server where the reputation of the sending mail server might be in jeopardy.

When calculating that a threshold may have been reached by an individual receiving mail server, the software of the present invention prevents the sending of any more mail to the receiving mail server's address until an administrator approves the resumption of sending email. This gives the administrator the option to not send any more mail to a mail server's address that might negatively impact the sending mail server's reputation with that receiving mail server. The present invention can be configured by the sending mail server administrator to react to a variety of pre-set values for reputation.

The present invention maintains responses from receiving mail servers regarding batch mail sent to them. The administrator may review the messages to determine why mail was not delivered. After determining the most likely cause for non-delivery, the administrator may optionally remove the batch from the mail server to prevent further delivery problems, or re-start the batch and send the remaining messages.

In accordance with one embodiment of the present invention, methods and apparatus for protecting the deliverability of electronic mail operating on sending mail servers are described. When sending email in a batch, a sender must use diligence to ensure that the receiving mail server is accepting a large percentage of the messages. If a receiving mail server receives too many messages that it declines to deliver, or it detects could be unwanted, the receiving mail server may optionally block the sending mail server and refuse to process any more mail from the sending mail server.

The present invention is designed to track the acceptance or rejection of email messages to the receiving email server and react if the percentage of undelivered messages to a particular receiving email server exceeds a pre-set threshold, as the messages are being sent. When the threshold is met, the present invention stops the mailing and presents the results of non-delivery attempts to the administrator, who can determine the next step.

The present invention begins operating when a sending mail server begins sending individual email messages in a batch. The messages are sent in a serial manner to individual email addresses on one or more receiving mail servers. The present invention maintains two counts simultaneously—one count of every message sent to each unique receiving mail server, the other count of every response message marked undeliverable returned from each sending email server. The present invention performs a running calculation based on the two counts and compares the calculated value to a pre-set value, which when met or exceeded stops sending any more mail in the batch. A calculation of reputation could be: Number of failures/Message attempted. Thus if there had been 10 failures and 100 messages attempted, the division results in a value of 0.1, or 10% failure rate.

When the software stops a batch mailing, it notifies the sending mail server administrator that the batch has been stopped, and provides information about undeliverable email messages. The operator may optionally re-start sending the batch of messages or remove the batch from the mail server for further analysis.

In this manner, an individual or company sending email can monitor and track the deliverability of their email and determine whether the deliverability rate is unacceptably low while the messages are being sent. This enables them to decide whether to continue sending email or stop sending email before reaching thresholds on receiving email servers that cause future mail to be delayed or blocked.

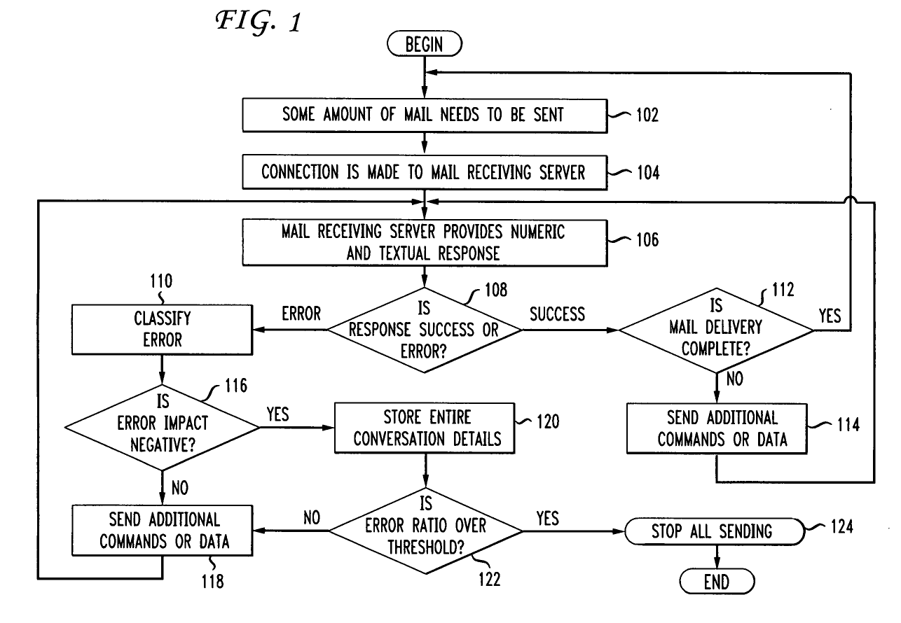

FIG. 1 is a flow diagram of a process of controlling the transmission of e-mail to a receiving mail server in accordance with one embodiment of the present invention. It will be understood that not every step provided for such a start or reboot process is necessary, that other steps might be included, and that the order of steps might be rearranged as desired for a given application. At step 102 the process of sending a batch of mail from a sending mail server to a receiving mail server is initiated. At step 104 the sending mail server makes a connection with the receiving mail server. The sending mail server makes a TCP/IP socket connection to a receiving mail server. Once the connection is established, a conversation occurs that follows the specification originally from RFP 821 for the sending of SMTP mail. This protocol, at a high level, describes two computers exchanging data in a specific order with specific verbs being used. The sending server issues commands or provides data. Processes for establishing a connection and transmitting mail are well known in the field. Once a connection is established between the two servers, the batch of mail is sent to the receiving server at the completion of step 104.

At step 106 the receiving server responds with one or more numeric codes and human-readable text, typically in English. The receiving mail server can choose to end the conversation at any step in the process by disconnecting. This may occur at the outset when the initial message is sent at the time the connection is first established in step 104 or may occur at any point during the process. The response error message text may be examined by the server administrator and there are many possible wordings for the error message. Each mail message that is sent to the receiving server results in some type of response received at the sending server.

At step 108 the response, either a numeric response and/or a response text message, is examined by the software (in the case of a numeric response) or by an administrator (in case of a text message). If the response is an error, control goes to step 110. If the response conveys a successful transmission, control goes to step 112. At step 112 the system checks whether all the mail messages have been sent. If they have not, control returns to step 102 where the remaining mail in the batch is transmitted. If all the mail in the batch has been sent, control goes to step 114 where additional commands and data, such as another batch of mail, may be sent and the process repeats by returning to step 106.

Returning to step 108, if the response from sending a mail message indicates an error, at step 110 the error is classified. In one embodiment, the numeric response and/or the text in the error message are classified into one of three classifications according to how they may effect the reputation of the sending mail server: positive, negative and neutral. Positive errors are errors that are not likely to impact the reputation in a negative way and, thus, may improve the reputation of the sending mail server. Negative errors are errors that are likely to decrease the reputation of the sending mail server. Neutral errors are errors that are likely to have no impact on reputation. Examples of negative errors may include: An error number of value 500 or above during the step of sending MAIL FROM, RCPT TO, or in the initial text returned by the server when connecting. These words correspond with specific verbs from the SMTP protocol, as does the significance of the 500 and higher value for error codes.

Other factors could be considered for determining whether to stop a batch of emails from being sent. For example, some email message may have many words in the content that causes the mail receiving server to react very negatively to the mailing, but other emails sent from the same sending server does not trigger the same negative reaction; thus, one embodiment may cause the reputation-damaging content version to be stopped but allow other content batches to be sent. Thus, the one bad email message that was damaging the reputation would be stopped but the others would be allowed to continue, maintaining the good reputation of the sending server.

Once the error has been classified, at step 116 the system checks whether the error is one that is likely to damage the reputation score of the sending mail server. If it is not (i.e., it has been classified as a positive or neutral error), control goes to step 118 where additional commands, data or mail may be sent to the receiving server and control returns to step 106 where the system checks for responses to the additional data that was sent at step 118.

The classifier may look at several different factors to determine the likelihood of the response being reputation damaging. One piece of criteria is the step in the STMP process. Since each step has some significance associated with it, errors in some steps are more of a concern than in other steps. Using verbs specific to the SMTP protocol, responses that are returned with numeric value 500 and above after the connection is established, or from the MAIL FROM or RCPT TO steps, would be classified as reputation damaging. Errors of 500 and above during the HELO/EHLO step or after QUIT would not be considered reputation damaging. The textual response to the error is also considered so that messages that include words such as “Too many connections”, “Die, spammer”, or “Mailbox full” are considered by the classifier.

If the error is classified as negative, control goes to step 120 where details of the conversation between the two servers that started at step 104 is stored on the sending mail server in a manner where it can be analyzed by an administrator. An administrator may examine a record of the conversation (which includes details of all communications between the two servers) to make a qualitative determination as to whether to continue with sending mail. At step 122 the system determines whether the negative-impacting error increases the error ratio over a threshold ratio. In one embodiment, the error ratio may be the ratio of negatively-impacting error messages to total messages sent. The threshold ratio is a ratio having the same variables and is set by a network administrator. The error ratio for a batch of 100 mail messages that resulted in 18 negatively-impacting error messages has an error ratio of 18:100 (or 18%). If the next 50 messages result in 5 more negative errors, the error ratio will have decreased slightly to 23:150 (or 15.3%). In order to continuously calculate this ratio, the system maintains a running count of all mails sent and the number of negative errors messages that result from such mail messages. Of course, this ratio may be calculated after each mail is sent and will change depending on the number of negative errors received from the receiving mail server.

The threshold error ratio is a ratio set by the administrator after taking into consideration several factors, such as the source of the email addresses, the frequency of the transmissions to the receiving server, how much risk the sending entity is willing to take with that particular receiving mail server, and the need for timely mail delivery. The threshold ratio may also be set in relation to the tolerance level of the receiving server. The administrator may know that the receiving server may blacklist or ban the sending server if the number of error response codes exceeds a certain number or ratio. The administrator may want to set a threshold error ratio on the sending server that is safely below this number or ratio. For example, the administrator may decide that if the actual error ratio exceeds 19%, the sending mail server should cease all transmissions to that server because the ratio for the receiving server is 23%.

As described above, this ratio may be calculated continuously with each mail sent. In the example above, if the next seven emails sent resulted in a negative error, the ratio will have increased to 30:157, or 19.1% and the system will block the further transmission of mail at step 124. If the ratio remains below the threshold ratio, control goes to step 118 where additional commands or data may be sent. In other embodiments, different methods may be used to calculate the error ratio. For example, in a slightly different calculation, the ratio may be derived using weighted calculations where some errors would results in more likelihood of reputation damage and other errors would be less likely, although not completely risk free, so these errors would be given a lower significance. A variety of different value, calculations, and indicators may be used to measure the success rate of sending messages.

The software can also send an alert to the administrator of the sending mails server that contains all the messages that occurred between the sending mail server and the receiving mail server for the batch that caused the threshold to be exceeded. This enables the administrator to review the description of the errors and make a more nuanced or subjective decision as to whether the mailing server should be allowed to continue sending messages to the receiving server. The software provides a mechanism that enables the administrator of the sending mail server select whether to continue sending email or stop the attempts, either temporarily or permanently.

Thus, to summarize and in one embodiment of the invention, the sending mail server begins the process by sending multiple email messages in a batch to various receiving email servers. In one embodiment, this triggers the software of the present invention to start tracking the process.

The receiving mail servers return information to the sending mail server regarding every message they receive from the sending mail server, and indicates whether the message was received successfully and delivered to the addressee, or if the message was not delivered for any of a number of possible reasons. The software records every success message and every failure message for each server and calculates a running score measuring the success of the delivery of mail to the receiving mail server. The software compares the running score against a pre-set value that, when met, indicates the receiving mail server is returning too high a rate of failures. The software stops the sending of any more mail to that mail server, and notifies the sending mail administrator that the sending of mail to that server has been stopped.

The logic described below may be used to determine whether a particular return error code will negatively impact the reputation of the sending mail server or will be positive or neutral. It is merely one example of a particular implementation with respect to step 116 of FIG. 1 and a person of ordinary skill in the art will recognize that other implementations are possible.

```
    Bool AffectesReputation;
If (Step == MailFrom)
{
    If (ResponseCode > 400 and ResponseCode < 500)
        AffectsReputation = false;
    Else if (ResponseCode >= 500)
        AffectesReputation = true;
}
Else if (Step == RcptTo)
{
    If (ResponseCode > 400 and ResponseCode < 500)
        AffectsReputation = false;
    Else if (ResponseCode >= 500)
        AffectesReputation = true;
}
Else if (Step == Data)
{
    AffectsReputation = false;
}
Else if (Step == AfterData)
{
    If (ResponseCode > 400 and ResponseCode < 500)
        AffectsReputation = false;
    Else if (ResponseCode >= 500)
        AffectesReputation = true;
}
```

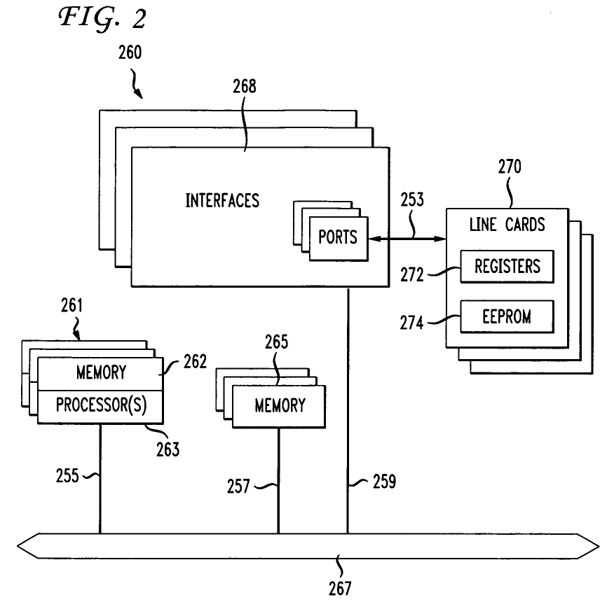

FIG. 2 is a block diagram showing the internal hardware components of an example sending mail server or equivalent network device that may be configured to implement methods or portions of methods of the present invention. Network device 260 includes a master central processing unit (CPU) 262, interfaces 268, and a bus 267 (e.g., a PCI bus). Generally, interfaces 268 include ports 269 appropriate for communication with the appropriate media. In some embodiments, one or more of interfaces 268 includes at least one independent processor 274 and, in some instances, volatile RAM. Independent processors 274 may be, for example ASICs or any other appropriate processors. According to some embodiments, these independent processors 274 perform at least some of the functions of the logic described herein. In some embodiments, one or more of interfaces 268 control such communication-intensive tasks as media control and management. By providing separate processors for the communication-intensive tasks, interfaces 268 allow the master microprocessor 262 efficiently to perform other functions such as routing computations, network diagnostics, security functions, etc.

The interfaces 268 are typically provided as interface cards (sometimes referred to as “line cards”). Generally, interfaces 268 control the sending and receiving of data packets over the network and sometimes support other peripherals used with the network device 260.

When acting under the control of appropriate software or firmware, in some implementations of the invention CPU 262 may be responsible for implementing specific functions associated with the functions of a desired network device. According to some embodiments, CPU 262 accomplishes all these functions under the control of software including an operating system and any appropriate applications software.

CPU 262 may include one or more processors 263 such as a processor from the Motorola family of microprocessors or the MIPS family of microprocessors. In an alternative embodiment, processor 263 is specially designed hardware for controlling the operations of network device 260. In a specific embodiment, a memory 261 (such as non-volatile RAM and/or ROM) also forms part of CPU 262. However, there are many different ways in which memory could be coupled to the system. Memory block 261 may be used for a variety of purposes such as, for example, caching and/or storing data, programming instructions, etc.

Regardless of network device's configuration, it may employ one or more memories or memory modules (such as, for example, memory block 265) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher level code that may be executed by the computer using an interpreter.

Although the system shown in FIG. 2 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces/line cards may be bus based (as shown in FIG. 2) or switch fabric based (such as a cross-bar).

Finally, although various advantages, aspects, and embodiments of the present invention have been discussed herein with reference to various example implementations, it will be understood that the scope of the invention should not be limited by reference to such advantages, aspects, and embodiments. Rather, the scope of the invention should be determined with reference to the appended claims.

What is claimed is:

1. A method of controlling the transmission of electronic mail, the method comprising:
transmitting a plurality of message from a sending mail server to a receiving mail server;
receiving a plurality of codes from the receiving mail server in response to receiving the plurality of messages;
determining which codes from the plurality of codes received are of a first type;
determining which of the codes of the first type are of a second type;
maintaining a first count of codes of the second type;
maintaining a second count of a total number of messages sent in the plurality of messages;
determining whether to continue transmission of messages to the receiving mail server by utilizing the first count and the second count,
thereby maintaining a reputation of the sending mail server.

2. A method as recited in claim 1 wherein the first type of code is an error code.

3. A method as recited in claim 1 wherein the second type of code is a reputation-impacting error code.

4. A method as recited in claim 1 wherein determining whether to continue transmission further comprises computing a ratio value using the first count and the second count.

5. A method as recited in claim 4 wherein determining whether to continue transmission further comprises comparing the ratio value to a pre-determined threshold ratio value.

6. A method of controlling the sending of electronic mail, the method comprising:
for a batch of email messages sent from a sending mail server, monitoring information that is returned from a receiving mail server regarding the email messages the receiving mail server receives from the batch;
based on the information, dividing the messages sent into a success return messages group, wherein the information confirms the successful delivery of an email message and a failure return messages group, wherein the information explains why the receiving mail server did not accept an email message;
maintaining a count of success return messages and a count of failure return messages;
calculating a running rate of success for the receiving mail server;
comparing the running rate of success against a pre-determined threshold value, wherein when the running rate of success meets the pre-determined threshold value, a sending mail server stops the sending of more email messages in the batch; and
notifying a sending mail server administrator that the email batch was stopped because the pre-determined threshold value met or exceeded.
